(19) United States
(12) Patent Application Publication
(10) Pub. No.: US 2004/0112234 A1
(43) Pub. Date: Jun. 17, 2004

(54) Protecting device for a printing machine cylinder

(76) Inventors: Franz Konrad Mezger, Lauda-Konigshofen (DE); Horst-Walter Hauer, Wurzburg (DE); Kurt Johannes Weschenfelder, Zell/Main (DE)

Correspondence Address: Douglas R Hanscom, Jones Tullar & Cooper, Eads Station, PO Box 2266, Arlington, VA, 22202, US

(21) Appl. No.: 10/475,846

(22) PCT Filed: Mar. 26, 2002
(86) PCT No.: PCT/DE02/01089

(30) Foreign Application Priority Data
May 12, 2001 (DE) 101 23 324.8

(51) Int. Cl. B41F 1/34

(52) U.S. Cl. 101/480

(57) ABSTRACT

A risk-free flying changeover of printing plates may be achieved, by means of a protecting device for a printing machine cylinder. The above is achieved whereby the protecting device is embodied as a rotating ring (08), on which is arranged a sleeve-shaped cover (09) for the partial enveloping of the cylinder (01, 02), at a separation therefrom.

The invention relates to a protective device for a cylinder of a printing press in accordance with the preamble of claims 1 or 9.

A protective device on forme cylinders is known from DE 196 03 666 C2, which is embodied to be pivotable by rotating the eccentric bearing bushings.

The object of the invention is based on producing a protective device for a cylinder of a printing press.

In accordance with the invention, this object is attained by means of the characteristics of claims 1 or 9.

The advantages to be gained by means of the invention lie in particular in the protection from inadvertent touching of rotating cylinder elements in the course of printing plate changes. The protective device is not connected with eccentric bushings, so that no additional drive mechanism for compensating different pivot movements is required.

An exemplary embodiment of the invention is represented in the drawings and will be described in greater detail in what follows.

Shown are in:

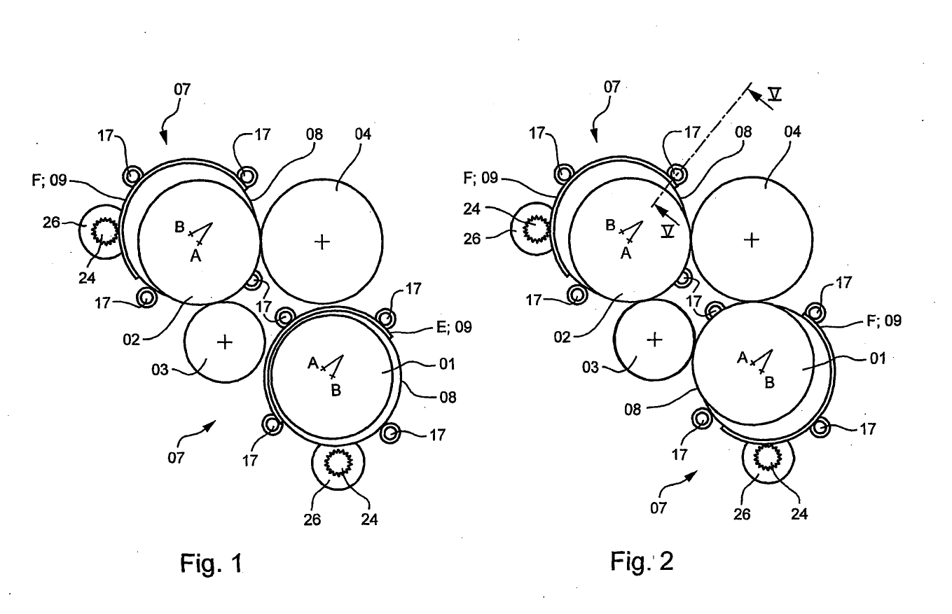

FIG. 1, a lateral view of a printing group in a principal representation, having two plate cylinders which can be brought into and out of contact, wherein the first plate cylinder is in a print-off position, and the associated cover is opened,

FIG. 2, a representation analogous to FIG. 1, however the first plate cylinder is in a print-on position and the cover is closed,

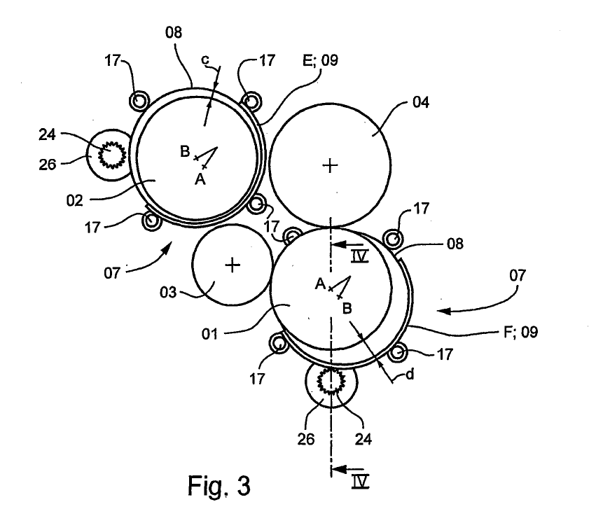

FIG. 3, a representation analogous to FIG. 1, however the second plate cylinder is in a print-off position, and the associated cover is opened,

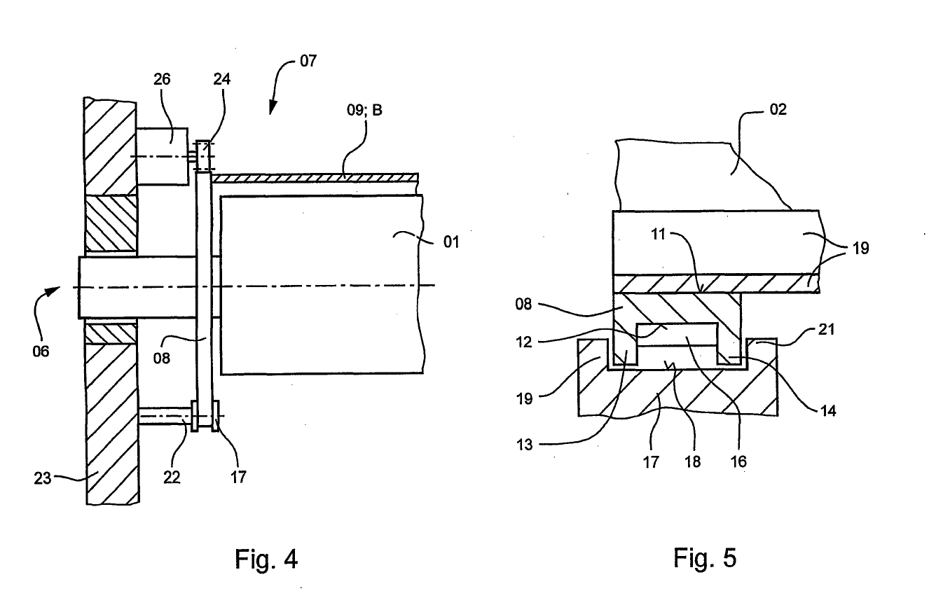

FIG. 4, a section IV-IV through the first plate cylinder in accordance with FIG. 3, wherein an upper spacing holder 22, as well as the associated holding roller 17 have been omitted, FIG. 5, a section V-V in accordance with FIG. 2 in an enlarged partial representation.

A printing group, for example for flexographic printing, consists of two cylinders 01, 02, each of which can be equipped with printing plates, for example printing or forme cylinders 01, 02, which can be placed either together or individually against a cylinder 03, for example a counter-pressure cylinder 03, as well as a roller 04, for example a screen roller 04. The predominantly individual placement of the forme cylinders 01, 02 is performed in each case by means of eccentric bearing bushings 06 (FIG. 4). In this way either a print-on position A, or a print-off position B of the forme cylinders 01, 02 results.

The screen roller 04 is connected with an ink application arrangement, not represented. All cylinders 01, 02, 03 and the roller 04 can be separately driven, for example by non-represented drive motors.

A protective device 07 for the forme cylinders 01 or 02 consists of a rotatable ring 08, on which a sheath-shaped or trough-shaped cover 09 is fastened. The cover 09 encloses approximately half the circumference of the forme cylinder 01 or 02.

On its interior circumference 11, the ring 08 has the sheath-shaped cover 09. On its outer circumference, the ring 08 has two annular tori 13, 14, which are spaced apart from each other and between which, viewed in the circumferential direction of the ring 08, a toothed device 16, or the like, is arranged.

The ring 08 is maintained by several, for example four, holding rollers 17, which are arranged evenly distributed over the circumference of the ring 08. In the process, the outer edges of the tori 13, 14 act on a running surface 18, which is embodied in the manner of a groove bottom, on the circumference of the holding rollers 17, wherein lateral walls 19, 21 secure the respective ring 08 against axial displacement. The holding rollers 17 are seated on the free ends of respective spacing holders 22 in a lateral frame 23, for example.

In an out-of-contact position, i.e. in the print-off position B, the periphery of the forme cylinder 01 or 02 is remote from the cover 09 by a minimum distance c, and in an contact position, i.e. in the print-on position A, by a maximum distance d.

The ring 08 can be rotated manually or by means of a pinion 24, which engages the toothed device 16 and can be driven, i.e. rotated, by means of a drive motor 26 fixed in place in the lateral frame.

Each cover 09 of the protective device 07 can be rotated into two positions: cover 09 “open” in the position E, or cover 09 “closed” in the position F, each viewed from the operating side.

For exactly fixing the two positions E, F of the cover 09, non-represented limit stop switches fixed in place in the lateral frame, for example, as well as cams fixed on the ring, can work together, or it is possible to provide markers fixed on the ring and sensors fixed in place of the lateral frame, or the like can be provided.

The function of the protective device 07 is as follows:

In accordance with the representation in FIG. 1, the cylinders 02, 03 and the roller 04 rotate, while the first forme cylinder 01 is in the print-off position and the cover 09 is in the “open” position E. A plate change can now be performed.

In accordance with the representation in FIG. 2, all cylinders 01, 02, 03 and the roller 04 rotate. In this case all covers 08 have been rotated into the “closed” position F.

In accordance with FIG. 3, the second forme cylinder 02 is in the print-off position, wherein the cover 09 is in the “open” position E. A plate change can be performed, etc.

Because of a locking device, the cover 09 can only be rotated into the position “open” E in the print-off position B.

It is also possible to use different drive mechanisms for the protective device 07, for example toothed belts or the like.

It is also conceivable for the cover 09 to have its own actuating drive, which can be operated independently of an actuating drive for bringing a cylinder 01, 02 into or out of contact. The cover 09 can be selectively placed into a gap between two cylinders 01, 03; 02, 03, or into a gap between a cylinder and a roller 01, 04; 02, 04.

In accordance with another embodiment variation, not represented, in a 10-cylinder satellite printing group respectively two rubber blanket cylinders can operate against a counter-pressure cylinder in accordance with the imprinter principle, wherein a forme cylinder, which can be pivoted in and out, is assigned to each rubber blanket cylinder.

If it is now intended to take one of the two forme cylinders 01, 02 out of production, for example for a flying plate change, the respective forme cylinder 01, 02 is pivoted away from the rubber blanket cylinder and the counter-pressure cylinder, for example by means of eccentric bushings. In this case each rubber blanket cylinder has an analogous protection device 07. The latter can be rotated in such a way that, with the forme cylinder 01, 02 stopped and the rubber blanket cylinders rotating, each rubber blanket cylinder is covered in the handling area.

Suitably each cover 09 is supported on both ends, i.e. from the direction of both lateral frames, with respectively one ring 08, and by the associated holding rollers 17, seated fixed in the lateral frames.

List of Reference Numerals

01 Cylinder, forme cylinder, first

02 Cylinder, forme cylinder, second

03 Cylinder, counter-pressure cylinder

04 Roller, screen roller

05 -

06 Eccentric bearing bushing

07 Protective device

08 Ring (07)

09 Cover (08)

10 -

11 Interior circumference (08)

12 Exterior circumference (08)

13 Torus (08)

14 Torus (08)

15 -

16 Toothed device (08, 12)

17 Holding roller (08)

18 Running surface (17)

19 Lateral wall (18)

20 -

21 Lateral wall (18)

22 Spacing holder (17)

23 Lateral frame

24 Pinion (20)

25 -

26 Drive motor (23)

A Print-on position (01, 02)

B Print-off position (01, 02)

E Position, cover open (09)

F Position, cover closed (09)

c Distance, minimal (09)

d Distance, maximal (09)

1. A protective device for a cylinder of a printing press for the selective covering of rotating cylinder elements, characterized in that the protective device (07) has a rotatable ring (08), on which a sheath-shaped cover (09) for the partial, distanced covering of the cylinder (01, 02) is arranged.

2. The protective device in accordance with claim 1, characterized in that the cover (09) is embodied in a trough shape.

3. The protective device in accordance with claim 1, characterized in that the ring (08) can be driven by means of a drive motor (26).

4. The protective device in accordance with claim 1, characterized in that the ring (08) is seated fixed in place in a lateral frame.

5. The protective device in accordance with claim 1 or 2, characterized in that the cover (09) is fastened on the ring (08).

6. The protective device in accordance with claim 1, characterized in that the cover (09) is connected with a position indicating device.

7. The protective device in accordance with claim 1, characterized in that the cylinders (01 or 02) are respectively embodied as rubber blanket cylinders.

8. The protective device in accordance with claim 1, characterized in that the cover (09) is supported from the direction of a first lateral frame (23) by means of a ring (08) and associated holding rollers (17).

9. A protective device for a cylinder of a printing press for the selective covering of rotating cylinder elements, wherein the cover (09) can be selectively placed into a gap between two cylinders (01, 03; 02, 03), or a gap between a cylinder and a roller (01, 04; 02, 04), characterized in that the cover (09) is assigned its own actuating device (26).

10. The protective device in accordance with claim 9, characterized in that the actuating device (26) can be operated independently of an actuating device for bringing a cylinder (01, 02) into or out of contact.
